(19) United States
(12) Patent Application Publication
(10) Pub. No.: US 2017/0084420 A1
(43) Pub. Date: Mar. 23, 2017

(54) ROTARY-ANODE TYPE X-RAY TUBE

(71) Applicant: Toshiba Electron Tubes & Devices Co.,Ltd., Otawara-shi (JP)

(72) Inventors: Harunobu FUKUSHIMA, Tokyo (JP); Tetsuya Yonezawa, Yaita (JP); Hitoshi Hattori, Yokohama (JP)

(73) Assignee: Toshiba Electron Tubes & Devices Co.,Ltd., Otawara-shi (JP)

(21) Appl. No.: 15/369,259

(22) Filed: Dec. 5, 2016

Related U.S. Application Data
(63) Continuation of application No. PCT/JP2015/058336, filed on Mar. 19, 2015.

(30) Foreign Application Priority Data
Jun. 5, 2014 (JP) 2014-116872

(51) Int. Cl. H01J 35/10; H01J 35/26

(52) U.S. Cl. CPC H01J 35/101; H01J 35/26

(57) ABSTRACT

In a rotary-anode type X-ray tube, an annular groove is annularly formed on a first surface of a rotary-anode. The annular groove is so extended as to be surrounded by an anode target and is arranged around a rotation axis of the rotary-anode is in rotation symmetry with respect to an axis of rotation. Slits are so formed in the rotary-anode as to be arranged around the rotation axis in rotation symmetry with respect to the rotation axis, each of the slits is cut in the rotary-anode and extended in the in communication with the annular groove, and through holes are communicated with the respective slits, and each of the through holes is opened in the annular groove, and is extended from the annular groove to the opposite surface.

### CROSS REFERENCE TO RELATED APPLICATIONS

This application is a Continuation Application of PCT Application No. PCT/JP2015/058336, filed Mar. 19, 2015 and based upon and claiming the benefit of priority from Japanese Patent Application No. 2014-116872, filed Jun. 5, 2014, the entire contents of all of which are incorporated herein by reference.

### FIELD

Embodiments described herein relate generally to a rotary-anode type X-ray tube.

### BACKGROUND

In many cases, a rotary-anode type X-ray tube is built into a medically applied diagnostic imaging device which uses X-ray photography for diagnosis. In a rotary-anode type X-ray tube, an anode used as an anode target is made to rotate at a high speed in a housing maintained at a high vacuum, and an electron beam is made to impinge on the rotary-anode target, whereby X-rays are discharged from the anode target.

The impingement of the electron beam on the anode target will generate heat which will affect the anode target. However, since the anode is made to rotate at a high speed, the heat generated by the impingement of the electron beam on the anode target will not concentrate at one point of the anode target, but will scatter around the entire surface of the anode target, thereby preventing the anode target from being overheated and damaged. The heat generated by the impingement of the electron beam on the anode target will scatter around the entire surface of the anode target to be conducted to the outer surface of the X-ray tube because of thermal conduction effect and will be eventually discharged from the outer surface of the X-ray tube to the atmosphere. In the process of thermal conduction, a large thermal difference may occur among various portions of the anode, which will induce strong thermal stress in the anode. Therefore, there is a possibility that the anode will be damaged by the thermal stress in some cases.

In recent years, a medically applied X-rays CT device is requested to accelerate tomography process.

Thus, a rotary-anode type X-ray tube developed in response to the request is required to generate much larger X-rays output. Therefore, the developed rotary-anode type X-ray tube tends to be large in input of an electron beam applied to its anode. As a result, the anode will suffer increase in heat and thermal stress generated by application of an electron beam, and thus it is worried that the anode might be short in its service life. With these issues, it is demanded to develop an X-ray tube which surely generates large output X-rays, whereas surely reduces thermal stress, thereby firmly securing a predetermined service life.

U.S. Pat. No. 8,126,116 B2 of Bathe discloses a rotary-anode type X-ray tube which has such a structure that relieves an anode target from too much thermal stress. The rotary-anode type X-ray tube disclosed in U.S. Pat. No. 8,126,116 B2 has slits and holes. Each of the slits extends along a radius of the target from the outer periphery of the target toward the central part of the target. The holes are circumferentially arranged at the central part of the target, and are in communication with the respective slits. In this way, the structure having the slits and the holes is supposed to relieve the target from too much generation of thermal stress.

U.S. Pat. No. 8,126,116 B2 of Bathe confesses that there is a problem that a mere provision of holes which are in communication with corresponding slits cannot prevent occurrence of a strong stress circumferentially affecting each of the holes. U.S. Pat. No. 8,126,116 B2 discloses an anode having slits which are extended from an outer periphery of the anode to a central part of the anode, and holes at the central part in communication with the respective slits. In this anode structure, a stress reduction material which is united with a target material is provided in the holes of the anode to relieve both the target and the holes from any stress. However, as explained in U.S. Pat. No. 8,126,116 B2 of Bathe, the provision of the stress reduction material united with the target material in the holes will incur an increase in cost and an increase in manufacturing process, since the stress reduction material is different from the target material. In addition, there is a possibility that cracks may occur at the interface between the two different materials because of variation in dimensional tolerance or difference in manufacturing process, resulting in occurrence of various problems, including separation of two materials.

### BRIEF DESCRIPTION OF THE DRAWINGS

FIG. 1 is a cross-sectional view schematically illustrating an X-ray tube assembly having a rotary-anode type X-ray tube in a first embodiment.

FIG. 2 is a front view schematically illustrating an anode structure, which an X-ray tube in the first embodiment has, with the electron gun in FIG. 1 considered to be situated in front.

FIG. 3 is a cross-sectional view schematically illustrating a partial section of the anode taken along line A-A illustrated in FIG. 2.

FIG. 4 is a partial cross-sectional view schematically illustrating a portion of the anode for conceptually explaining a thermal deformation caused, by the application of the electron beam, to occur at each through hole and each slit both provided at the anode illustrated in FIG. 2, and a mechanism of reduction in the thermal stress.

FIG. 5 is a partial cross-sectional view of a comparative example schematically illustrating a portion of the anode for conceptually explaining a thermal deformation caused, by the application of the electron beam, to occur at each through hole and each slit both provided at the anode illustrated in FIG. 2, and a mechanism of reduction in the thermal stress.

FIG. 6 is a partial cross-sectional view for illustrating with contour lines, the contour lines showing how a side surface of any slit formed in the anode as illustrated in FIG. 4 and FIG. 5 is affected by thermal deformation, and for explaining a mechanism of how the thermal deformation occurring at an opening of any through hole is reduced by providing an annular groove.

FIG. 7 is a front view schematically illustrating an anode structure, which an X-ray tube in a second embodiment has, with the electron gun in FIG. 1 considered to be situated in front.

FIG. 8 is a front view schematically illustrating an anode structure of an X-ray tube in a third embodiment with the electron gun in FIG. 1 considered to be situated in front.

### DETAILED DESCRIPTION

Embodiments of a rotary-anode type X-ray tube will be described hereinafter with reference to the accompanying drawings.

According to an embodiment, there is provided a rotary-anode type X-ray tube comprising:

an electron gun to emit an electron beam;

a rotary-anode having an axis of rotation, a first surface facing the electron gun, and a second surface opposite to the first surface, wherein

an anode target is formed on the first surface to generate X-rays upon impingement of the electron beam from the electron gun, the anode target being so annularly extended around the axis of rotation and is arranged in rotation symmetry with respect to the axis of rotation,

an annular groove is annularly formed in the first surface and is surrounded by the anode target on the first surface, and is arranged around the axis of rotation in rotation symmetry with respect to the axis of rotation,

slits are formed in the rotary-anode and are arranged around the axis of rotation in rotation symmetry with respect to the axis of rotation, each of the slits is cut in the rotary-anode and extended along the axis of rotation from the first surface to the second surface in communication with the annular groove; and

through holes are so formed in the rotary-anode as to be communicated with the respective slits, each of the through holes is opened in the annular groove, and is extended from the annular groove to the second surface and is opened at the second surface;

a support section on which the rotary-anode is rotatably fitted; and

a bearing rotatably supporting the rotary-anode on the support section.

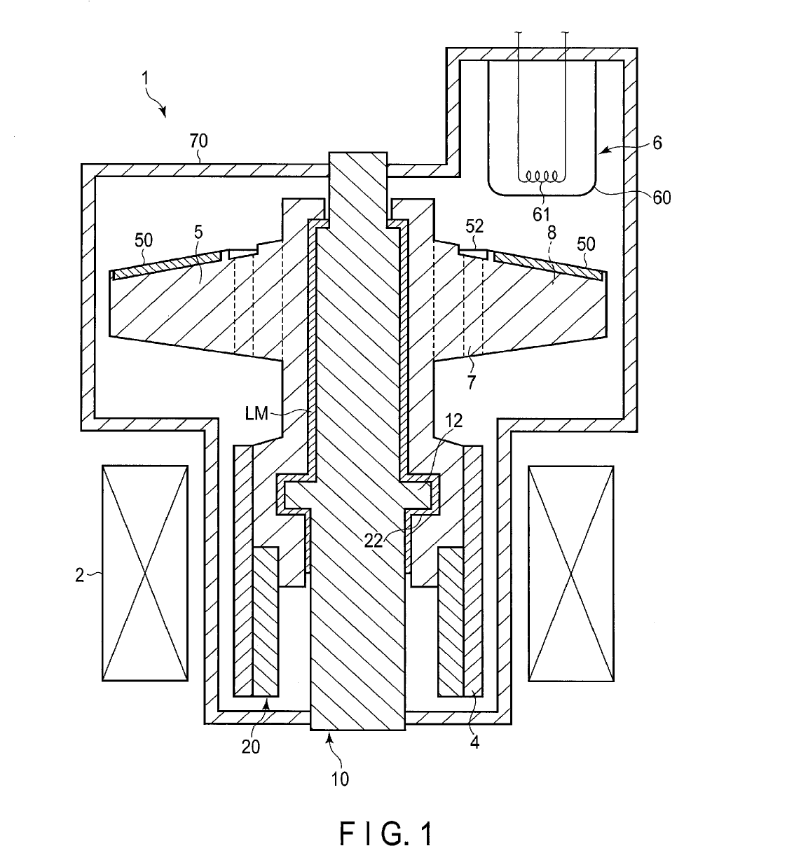

An X-ray tube assembly according to a first embodiment comprises a rotary-anode type X-ray tube 1 and a stator coil 2 for generating a magnetic field, as shown in FIG. 1. The rotary-anode type X-ray tube 1 comprises a rotary-anode 5 having an anode target 50, a cathode 60 which has a filament 61, and a vacuum envelope 70 which has an inside space maintained to be in a vacuum state, wherein the rotary-anode 5 and the cathode 60 is received in the vacuum envelope 70 and the cathode 60 is faced to the anode target 50 of the rotary-anode 5. Filament current is supplied to the filament 61. Accordingly, the application of high voltage between the anode target 50 and the cathode 60 causes electrons to be discharged from the filament 61 of the cathode 60. The discharged electrons are converged as an electron beam on the anode target 50 by a focus electrode (not illustrated) and are impinged on the anode target 50. The impingement of the electron beam on the anode target 50 causes the anode target 50 to generate X-rays, which are directed outward through an X-rays window (not shown).

Here, the cathode 60, the filament 61, and the focus electrode form an electron gun assembly 6 which emits an electron beam as a cathode structure. The rotary-anode 5 is formed as a disk shape, and is made of material such as heavy metal, for example, a molybdenum alloy. The anode target 50 is annularly formed on a surface of the rotary-anode 5 as a layer of heavy metal higher in fusing point than the material of the rotary-anode 5. The anode target 50 is a layer made of, for example, tungsten alloy (an X-ray radiating layer).

The rotary-anode type X-ray tube 1 has a fixed shaft 10 and a rotary member 20 to which the rotary-anode 5 is fixed. The rotary member 20 is rotatably supported on the fixed shaft 10. The fixed shaft 10 has two ends which are air-tightly fixed to the vacuum envelope 70. A motor rotor 4 is arranged coaxially with the stator coil 2 in the vacuum envelope 70 and is fixed to the rotary member 20. The motor rotor 4 is so arranged as to repel a magnetic field generated from the stator coil 2 so that the motor rotor 4 is rotated. A both-ends support structure is applied to the X-ray tube 1, wherein the fixed shaft 10 is fixedly supported at its both ends as shown in FIG. 1. However, the embodiment is not limited to the both-ends support structure. It is possible that the fixed shaft 10 may have a cantilever structure where one of the two ends of the fixed shaft 10 may be supported just like a cantilever.

The rotary member 20 is fit on the fixed shaft 10 with a narrow clearance (gap) between an inner surface of the rotary member 20 and an outer surface of the fixed shaft 10 which are faced to each other. A fine pattern such as a fine herringbone pattern, for example, is formed on at least one of the inner surface of the rotary member 20 and the outer surface of the fixed shaft 10. The fine patterns may be formed on both of the inner surface of the rotary member 20 and the outer surface of the fixed shaft 10, respectively. The narrow clearance and the minute pattern are filled up with liquid metal LM which is used as lubricant, thereby forming a slide bearing (radial bearing) allowing a radial support for the rotary member 20. As the rotary member 20 rotates, a dynamic pressure is produced on the liquid metal LM between the rotary member 20 and the fixed shaft 10, and is increased by the minute pattern depending on the rotation of the rotary member, so that the radial bearing which rotatably supports the rotary member 20 on the fixed shaft 10 is formed. Materials, such as a gallium indium (GaIn) alloy or a gallium indium and tin (GaInSn) alloy, can be used as the liquid metal LM.

The fixed shaft 10 is provided with a large diameter section 12 of disk-shape, which is larger in diameter than the fixed shaft 10. The rotary member 20 has an annularly recess section 22 which receives the disk-shaped large diameter section 12. The disk-shaped large diameter section 12 is fit in the annularly recess section 22 with an narrow clearance (gap) between them. The disk shaped large diameter section 12 has a cylindrical surface and two annular flat opposite surfaces. The annularly recess section 22 correspondingly has a cylindrical surface, which faces the cylindrical surface of the disk shaped large diameter section 12, and two annular flat opposite surfaces, which face the respective two annular flat opposite surfaces of the disk shaped large diameter section 12. A minute pattern such as a herringbone pattern, for example is formed on at least one of the annular flat opposite surfaces of the disk shaped large diameter section 12 and the annularly recess section 22, and an another minute pattern such as a herringbone pattern, for example is also formed on at least one of the another annular flat opposite surfaces of the disk shaped large diameter section 12 and the annularly recess section 22. The minute patterns may be formed on both of the annular flat opposite surfaces of the disk shaped large diameter section 12 and the annularly recess section 22. The narrow clearance and the minute pattern are filled up with liquid metal LM which is used as lubricant, whereby a slide bearing (thrust bearing) allowing an axial support for the rotary member 20 is formed. As the rotary member 20 rotates, a dynamic pressure is produced on the liquid metal LM between the disk-shaped large diameter section 12 and the annularly recess section 22, and is increased by the minute pattern depending on the rotation of the rotary member, so that the thrust bearing is formed, which rotatably supports the rotary member 20 in an axial direction of the fixed shaft 10 on the disk-shaped large diameter section 12.

The liquid metal LM between the rotary member 20 and the fixed shaft 10 is sealed with seal sections (not shown) provided between the fixed axis 10 and the both ends of the rotary member 20. The seal sections are formed to restrain the liquid metal LM from leaking and to function as, for example, a labyrinth seal ring, thereby keeping the rotary member 20 rotating. In addition, the liquid metal LM circulates through at least one of the rotary member 20 and the fixed shaft 10 in a replenishing manner. The liquid metal LM enables the rotary member 20 to stably rotate around the fixed shaft 10.

In the rotary-anode type X-ray tube 1, an electron beam is emitted from the electron gun assembly 6 to the rotary-anode target 50 and impinged on the rotary-anode target 50 which is rotated, as mentioned above, so that X-rays are generated from the target surface to which the electron beam is impinged. The energy used for generating X-rays is merely a several percentage of the energy of the electron beam, and 90% or more of the energy of the electron beam is changed into heat. Therefore, the anode target 50 will be high in temperature with this heat load. Accordingly, thermal stress occurs inside the rotary-anode 5 as will be describe below.

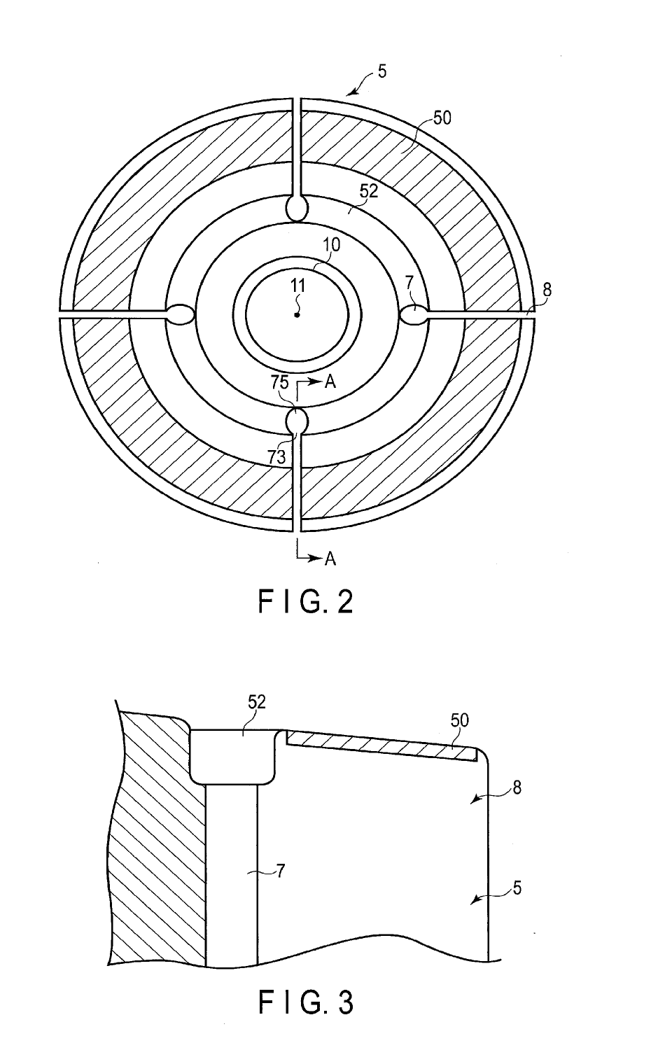

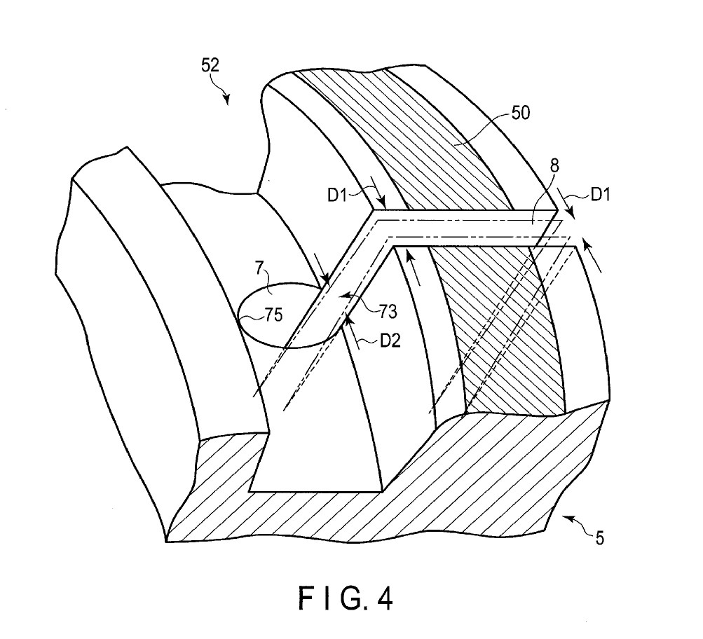

FIG. 2 is a front schematic view of the rotary-anode 5 of the X-ray tube of the first embodiment, in which the rotary-anode 5 is viewed from a front side where the electron gun is located. FIG. 3 illustrates a partial section of the rotary-anode 5 taken along line A-A illustrated in FIG. 2.

The rotary-anode 5 has an outer front surface which is inclined with respect to an imaginary reference surface (not shown) orthogonal to an axis of rotation 11. Here, the electron beam is focused to the anode target 50 and forms an elongated focal spot on the anode target 50 so that an annular ring shape spot is formed on the outer front surface of the rotary-anode 5 due to the rotating of the rotary-anode 5, the ring shape spot having a minute width extending along the radius of the rotary-anode 5. The annular ring shape spot is smaller in width than the target region of the anode target 50 on its front surface and is illustrated in FIG. 2 with oblique lines. The anode target 50 is larger in width than the annular ring shape spot depicted by the electron beam on the anode target 50, and the anode target 50 is made on the outer front surface of the rotary-anode 5 as an annular layer including the annular ring shape depicted by the electron beam to be in rotation symmetry with respect to the axis of rotation 11 wherein the annular ring shape ring is divided into ring parts by slits 8 described below.

The rotary-anode 5 has four slits 8 arranged to be in rotation symmetry with respect to the axis of rotation 11 as illustrated in FIG. 2. Each slit 8 is a cut which is formed in the rotary-anode 5 to extend from the front surface to the opposite surface. Furthermore, each slit 8 extends in the rotary-anode 5 from an outer circumference to an inner circumference in such a manner that each slit 8 cuts off the anode target 50 and extends to the fixed shaft 10. The rotary-anode 5 has an annular groove 52, i.e. ring-shaped groove, which is surrounded with the anode target 50 in the outer front surface of the rotary-anode 5. That is, the annular groove 52 is arranged more inward than the annular anode target 50 and is concentric with the annular anode target 50. The annular groove 52 is so formed in the rotary-anode 5 as to be in rotation symmetry with respect to the axis of rotation 11. The slits 8 are extended to annular groove 52, and are in communication with corresponding through holes 7 which are so formed in the rotary-anode 5 as to be opened in the annular groove 52. The through holes 7 extend from the bottom of the annular groove 52 to the opposite surface of the rotary-anode 5. The through holes 7 are also arranged in rotation symmetry with respect to the axis of rotation 11. Each of slit surface defining the slit 8 is so formed as to be oblique to a slit reference plane (not shown) which includes the axis of rotation 11 and is orthogonal to the imaginary reference orthogonal surface orthogonal to the axis of rotation 11. The slit reference plane passes through a center of a circumferential angle range around the axis of rotation 11, the center of a circumferential angle range of the slit surfaces defining each of the slits 8 around the axis of rotation 11. Moreover, it is possible that not only the slits 8 but also the axes of the respective through holes 7 may be oblique to the slit reference plane. It is also possible that the through holes 7 communicating with the respective slits 8 and the respective slits 8 themselves may not straightly extend along the axial direction but may so extend as to form a curved shape. In this case, the electron beam which strikes the front surface of the rotary-anode 5 will successively enter the slits 8, and will fall on the walls of the respective slits 8 without passing through the respective slits 8 and without exiting from the other side of the rotary-anode 5 to the outside of the rotary-anode 5. Therefore, generation of X-rays and heat will be restricted to the anode target alone. Not only the anode target 50 is formed to be in rotation symmetry with respect to the axis of rotation 11, but also the annular groove 52, the slits 8 each in communication with the annular groove 52, and the through holes 7 each opening to the annular groove 52 are formed to be in rotation symmetry with respect to the axis of rotation 11. Therefore, the rotary-anode 5 will be improved in rotation balance. As a result, the rotary-anode 5 rotates stably even though it has the slits 8, the annular groove 52, and the through holes 7.

When an electron beam strikes the rotary-anode 5 illustrated in FIG. 2, the rotary-anode 5 will expand because of the heat generated by the electron beam impinging on the anode target 50, and the slits 8 will be deformed as illustrated by arrows D1 in FIG. 4. The silts 8 having their respective openings at the front surface of the rotary-anode 5 will be affected by thermal expansion, and not only the openings will be narrow but also the slits 8 themselves will be narrow as a whole as indicated by arrows D1. Deformation of the opening of each of the slits 8 indicated by arrows D1 is called a communication side deformation. When the anode target 50 thermally expands, the through holes 7 communicating with the respective slits 8 will be contracted. Specifically, a communication side 73 which each of the through holes 7 is in communication with a corresponding one of the slits 8 will be narrow as indicated by arrows D2 as a corresponding one of the slits 8 narrows. Deformation of the communication side 73 of each of the through holes 7 indicated by arrows D2 is called a communication side deformation. The stress accompanying the communication side deformation of each of the through holes 7 is particularly concentrated on a base 75 which each of the through holes 7 has at a side opposite to the communication side 73.

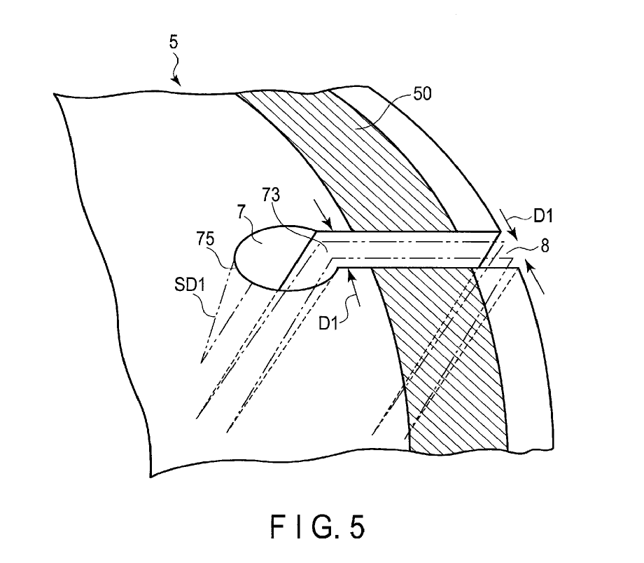

A rotary-anode 5 illustrated in FIG. 5 as a comparative example does not have an annular groove 52. Therefore, through holes 7 do not open into the annular groove 52. The through holes 7 directly open at a front surface which the rotary-anode 5 has and which is almost level with the surface of the anode target 50. As the slits 8 become narrow, the stress produced by the communication side deformation will be concentrated on a base 75 which each of the through holes 7 has as indicated by arrows D1. The stress concentrated on each of the bases 75 is correlated with how large the communication side deformation indicated by arrows D1 will be as a corresponding one of the slits 8 become narrow. Comparatively large stress SD1 will be applied to each of the bases 75. The rotary-anode 5 is repeatedly heated and cooled with the drive of the X-ray tube. Therefore, the rotary-anode 5 repeatedly expands and contracts, because of which the communication side deformation will repeatedly occur. The repetition of the communication side deformation is accompanied with comparatively large stress SD1, which will be applied to the base 75 of each of the through holes 7. Therefore, any base 75 may result in breakage after a lapse of time. However, in the rotary-anode 5 which has the annular groove 52 and the through holes 7 open to the annular groove 52, as illustrated in FIG. 4, the communication side deformation which occurs as indicated by arrows D2 at each of the through holes 7 which are opened at the bottom of the annular groove 52 is smaller than the communication side deformation which occurs as indicated by arrows D1 at each of the openings which the respective slits 8 have in the front surface of the rotary-anode 5. As a result, stress SD2 is repeatedly applied to the base 75 of each of the through holes 7. However, stress SD2 is smaller than stress SD1 occurring at the comparative example. Accordingly, the through holes 7 will be prevented from breaking at their respective bases 75 for a long time.

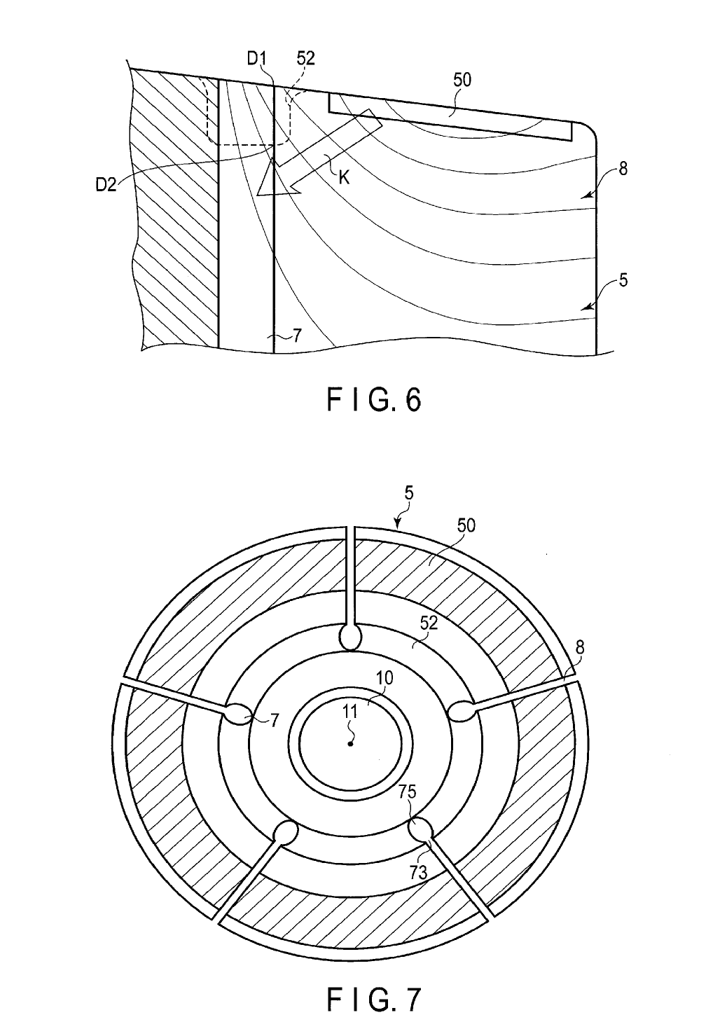

FIG. 6 illustrates thermal deformation which is represented in contour and occurs at a side, which any of the slits 8 in the rotary-anode 5 has, to make the slit 8 in question narrower. When an electron beam is applied to the anode target 50, the rotary-anode 5 will be heated as illustrated in FIG. 6. The anode target 50 is a heating source. Therefore, as represented by deformation contour lines, the rotary-anode 5 has the largest thermal deformation around the anode target 50, and, as it becomes distant from the anode target 50 as indicated by arrow K, thermal deformation becomes gradually small. In the comparative example, the annular groove 52 is not provided, and the through holes 7 are not open at the bottom of the annular groove 52 but are directly open at the front surface of the rotary-anode 5 which is level with the surface of the anode target 50 and is comparatively close to the anode target 50. It should be noted here that the region identified by mark D1 will be affected by a comparatively large communication side deformation. Therefore, comparatively large stress will be applied to the base 75 of each of the through holes 7. In contrast to the comparative example, the rotary-anode 5 of the present embodiment has the annular groove 52 which is illustrated in FIG. 2 and FIG. 3 and the through holes 7 which are open at the bottom of the annular groove 52. Accordingly, the through holes 7 are comparatively distant from the anode target 50. It is therefore apparent that a region identified by mark D2 will be relatively small in communication side deformation. Therefore, any stress applied to each of the bases 75 will also be comparatively small. Accordingly, the present embodiment will be smaller than the comparative example in the stress applied to each of the through holes 7, which makes it possible to prevent the bases 75 of the respective through holes 7 from breaking. Consequently, the first embodiment surely provides a rotary-anode type X-ray tube which generates large output X-rays, is very low in thermal stress affecting the rotary-anode 5, secures a predetermined service life, and stably rotates.

FIG. 7 illustrates an anode which is related to a second embodiment and has a structure which corresponds to a modification of the anode structure illustrated in FIG. 2. The rotary-anode 5 illustrated in FIG. 2 has an even number of slits 8, specifically, four slits 8 which are arranged in rotation symmetry with respect to the axis of rotation 11, whereas the rotary-anode 5 illustrated in FIG. 7 has an odd number of slits 8, specifically, five slits 8 which are arranged in rotation symmetry with respect to the axis of rotation 11. It does not matter whether there is an even number of slits 8 or an odd number of slits 8 so long as the number of slits 8 is one or more. All that is necessary to make small any stress applied to each of the through holes 7 is to make the slits 8 communicate with the respective through holes 7 which are open at the bottom of the annular groove 52 as illustrated in FIG. 7. Because of this structure, the stress applied to any of the through holes 7 will be kept small. As a result, the bases 75 of the respective through holes 7 will be prevented from breaking. Therefore, similarly to the first embodiment, the present second embodiment also provides a rotary-anode type X-ray tube which generates large output X-rays, is very low in the thermal stress affecting the rotary-anode 5, secures a predetermined service life, and stably rotates.

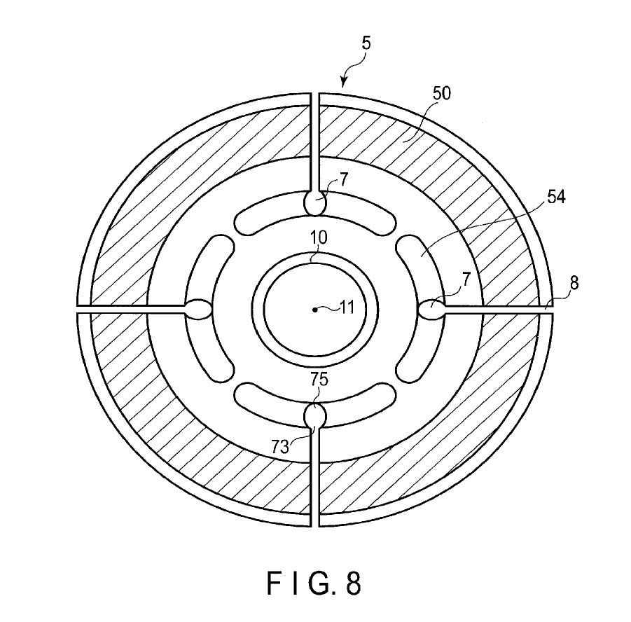

FIG. 8 illustrates an anode which is related to a third embodiment and has a structure which corresponds to a modification of the anode structure illustrated in FIG. 2. The rotary-anode 5 illustrated in FIG. 2 has the annular groove 52 continuously extending around the axis of rotation 11. In contrast to this, the rotary-anode 5 in the third embodiment illustrated in FIG. 8 does not have the continuously extending annular groove 52 but has four arc-shaped grooves 54 which correspond to four respective slits 8 and are arranged in rotation symmetry with respect to the axis of rotation 11. Each of the four arc-shaped grooves 54 has a bottom. Through holes 7 communicating with the respective four slits 8 open at the respective bottoms of the four arc-shaped grooves 54. It does not matter if the continuously extending annular groove 52 is replaced with the four arc-shaped grooves 54 which correspond to the respective four slits 8 as the anode of the third embodiment. All that is necessary to make small any stress applied to each of the through holes 7 is to make the slits 8 communicate with the respective through holes 7 which are open at the respective bottoms of the arc-shaped grooves 54. Because of this structure, the stress applied to any of the through holes 7 will be kept small. As a result, the bases 75 of the respective through holes 7 will be prevented from breaking. Therefore, similarly to the first and the second embodiment, the present third embodiment also provides a rotary-anode type X-ray tube which generates large output X-rays, is very low in the thermal stress affecting the rotary-anode 5, secures a predetermined service life, and stably rotates.

Any of the above embodiments surely provides a rotary-anode type X-ray tube which generates large output X-rays, is very low in the thermal stress affecting the rotary-anode 5, secures a predetermined service life, and stably rotates.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rotary-anode type X-ray tube comprising:
an electron gun to emit an electron beam;
a rotary-anode having an axis of rotation, a first surface facing the electron gun, and a second surface opposite to the first surface, wherein
an anode target is formed on the first surface to generate X-rays upon impingement of the electron beam from the electron gun, the anode target being so annularly extended around the axis of rotation and is arranged in rotation symmetry with respect to the axis of rotation,
an annular groove is annularly formed in the first surface and is surrounded by the anode target on the first surface, and is arranged around the axis of rotation in rotation symmetry with respect to the axis of rotation,
slits are formed in the rotary-anode and are arranged around the axis of rotation in rotation symmetry with respect to the axis of rotation, each of the slits is cut in the rotary-anode and extended along the axis of rotation from the first surface to the second surface in communication with the annular groove; and
through holes are so formed in the rotary-anode as to be communicated with the respective slits, each of the through holes is opened in the annular groove, and is extended from the annular groove to the second surface and is opened at the second surface;
a support section on which the rotary-anode is rotatably fitted; and
a bearing rotatably supporting the rotary-anode on the support section.

2. The rotary-anode type X-ray tube according to claim 1, wherein each of the slits is defines by slit surfaces, the slit surfaces are so spread as to have a circumferential angle range around the axis of rotation and are oblique to a slit reference plane including the axis of rotation and passing through a center line of the circumferential angle range.

3. The rotary-anode type X-ray tube according to claim 1, wherein the slits are arranged in rotation symmetry with respect to the axis of rotation.

4. The rotary-anode type X-ray tube according to claim 1, wherein the through holes are in rotation symmetry with respect to the axis of rotation.

5. A rotary-anode type X-ray tube comprising:
an electron gun to emit an electron beam;
a rotary-anode having an axis of rotation, a first surface facing the electron gun, and a second surface opposite to the first surface, wherein
an anode target is formed on the first surface to generate X-rays upon impingement of the electron beam from the electron gun, the anode target is so annularly extended around the axis of rotation and is arranged in rotation symmetry with respect to the axis of rotation,
arc-shaped grooves are formed in the first surface and is surrounded by the anode target on the first surface, and is arranged around the axis of rotation in rotation symmetry with respect to the axis of rotation,
slits are formed in the rotary-anode and are arranged around the axis of rotation in rotation symmetry with respect to the axis of rotation, each of the slits is cut in the rotary-anode and extended along the axis of rotation from the first surface to the second surface in communication with the arc-shaped groove; and
through holes are so formed in the rotary-anode as to be communicated with the respective slits, each of the through holes is opened in the arc-shaped groove, and is extended from the arc-shaped groove to the second surface and is opened at the second surface;
a support section on which the rotary-anode is rotatably fitted; and
a bearing rotatably supporting the rotary-anode on the support section.

6. The rotary-anode type X-ray tube according to claim 5, wherein each of the slits is defines by slit surfaces, the slit surfaces are so spread as to have a circumferential angle range around the axis of rotation and are oblique to a slit reference plane including the axis of rotation and passing through a center line of the circumferential angle range.

7. The rotary-anode type X-ray tube according to claim 5, wherein the slits are arranged in rotation symmetry with respect to the axis of rotation.

8. The rotary-anode type X-ray tube according to claim 5, wherein the arc-shaped grooves are in rotation symmetry with respect to the axis of rotation.

9. The rotary-anode type X-ray tube according to claim 5, wherein the through holes are in rotation symmetry with respect to the axis of rotation.
